(19) United States
(12) Patent Application Publication
(10) Pub. No.: US 2021/0026032 A1
(43) Pub. Date: Jan. 28, 2021

(54) DETECTION DEVICE AND DETECTION METHOD OF ELECTRONIC CIRCUIT DEVICE

(71) Applicant: Universal Entertainment Corporation, Tokyo (JP)

(72) Inventor: Jun HAISHIMA, Tokyo (JP)

(21) Appl. No.: 16/922,075

(22) Filed: Jul. 7, 2020

(30) Foreign Application Priority Data
Jul. 24, 2019 (JP) 2019-136284

(51) Int. Cl. G01V 3/12; G06K 7/10

(52) U.S. Cl. CPC G01V 3/12; G06K 7/10346

(57) ABSTRACT

An object of the present invention is to detect an electronic circuit device with small power. A detection device 1 detects an electronic circuit device 2 which has a unique resonance frequency and performs data communication by power obtained by resonance, and includes an antenna 11 configured to emit a radio wave at the resonance frequency to the electronic circuit device 2, an oscillation unit 12 configured to output an oscillation signal at the resonance frequency to the antenna 11, a resonance detection unit 13 configured to detect a resonant state occurring between the antenna 11 and the electronic circuit device 2, a determination unit 14 configured to determine existence of the electronic circuit device 2 on the basis of the resonant state detected by the resonance detection unit 13.

### CROSS-REFERENCE TO RELATED APPLICATION

This application claims the benefit of Japanese Patent Application No. 2019-136284 filed on Jul. 24, 2019, which application is incorporated herein by reference in its entirety.

### FIELD OF THE INVENTION

The present invention relates to a detection device and a detection method which detect an electronic circuit device performing data communication by power obtained by resonance.

### BACKGROUND OF THE INVENTION

Conventionally, in a case in which an RFID (radio frequency identifier) tag is used to detect an object, a detection device and an RFID tag are arranged to be in a resonant state, the RFID tag is activated by converting resonance energy to electric power, and data stored in the RFID tag is sent and received, so that the object is detected on the basis of content of the data of the RFID tag (see, e.g., International Publication No. 2017/168542).

In the conventional structure described above however, because electric power sufficient for activating the RFID tag is necessary to be obtained from the resonance energy, large electric power is required in the detection device which supplies the resonance energy.

### BRIEF SUMMARY OF THE INVENTION

The present invention has been made in view of the above. An object of the present invention is to provide a detection device and a detection method which make it possible to detect an electronic circuit device with small power.

The present invention is a detection device detecting an electronic circuit device which has a unique resonance frequency and performs data communication by power obtained by resonance, the detection device comprising:
an antenna configured to emit a radio wave at the resonance frequency to the electronic circuit device;
an oscillation unit configured to output an oscillation signal at the resonance frequency to the antenna;
a resonance detection unit configured to detect a resonant state occurring between the antenna and the electronic circuit device; and
a determination unit configured to determine existence of the electronic circuit device based on the resonant state detected by the resonance detection unit.

In the above-described structure, the electronic circuit device is detectable when the electronic circuit device and the antenna become in the resonant state, without increasing electric power used for resonance to a level at which data communication is possible.

The oscillation unit in the present invention includes a frequency changing unit which is configured to change the resonance frequency. In the above-described structure, the electronic circuit device is detectable in regard to the plural types which have different resonance frequencies.

The frequency changing unit in the present invention includes:
single oscillation units which output oscillation signals at different resonance frequencies; and
a connection switching unit which switches connection between the antenna and the single oscillation units.

In the above-described structure, an oscillation signal is able to be output to the antenna. In the oscillation signal, a bandwidth of the resonance frequency is finely separated.

The oscillation unit in the present invention includes:
an oscillator which is configured to output the oscillation signal; and
a field effect transistor which includes a base terminal into which the oscillation signal is input from the oscillator and a drain terminal connected to the antenna, and is configured to control a current of the oscillation signal running in the antenna by controlling a current between the drain terminal and a source terminal in accordance with a gate voltage of the oscillation signal which is input into the base terminal, and
the resonance detection unit includes:
a gate voltage detection unit which is configured to detect the gate voltage of the oscillation signal which is input into the base terminal; and
a resonant state determination unit which is configured to determine existence of the resonant state based on the gate voltage detected in the gate voltage detection unit.

In the above-described structure, the resonant state is detectable with a simple circuit structure.

The antenna in the present invention includes an opening portion which allows a person with the electronic circuit device to pass through.

In the above-described structure, by setting the antenna so that a passage is placed in the opening portion, it is able to avoid, for example, a situation in which the antenna obstructs a person from walking.

The present invention is a detection method of detecting an electronic circuit device which has a unique resonance frequency and performs data communication by power obtained by resonance, the detection method comprising the steps of:
outputting an oscillation signal at the resonance frequency to an antenna which is provided to emit a radio wave to the electronic circuit device; and
detecting the electronic circuit device based on a resonant state occurring between the antenna and the electronic circuit device.

In the above-described structure, the electronic circuit device is detectable when the electronic circuit device and the antenna become in the resonant state, without increasing power used for resonance to a level at which data communication is possible.

In the present invention, the electronic circuit device is detectable with small electric power.

### BRIEF DESCRIPTION OF THE DRAWINGS

FIG. 1 is an explanatory diagram showing a detecting process by a detection device.

FIG. 2 is an electric circuit diagram of the detection device and an electronic circuit device in a resonant state.

FIG. 3 is a block diagram of the electronic circuit device.

FIG. 4 is an explanatory diagram showing the relationship between a current and a frequency in the resonant state.

FIG. 5 is an electrical block diagram of the detection device.

FIG. 6 is an explanatory diagram of the detection device.

FIG. 7 is an explanatory diagram of the detection device.

FIG. 8 is an explanatory diagram of the detection device.

FIG. 9 is an explanatory diagram of the detection device.

FIG. 10 is an electrical block diagram of the detection device.

FIG. 11 is an explanatory diagram of a chip determination table.

FIG. 12 is a flowchart of a chip detecting process.

### DETAILED DESCRIPTION OF THE PREFERRED EMBODIMENT

The following will describe one embodiment of the present invention with reference to figures.

### Detection Device

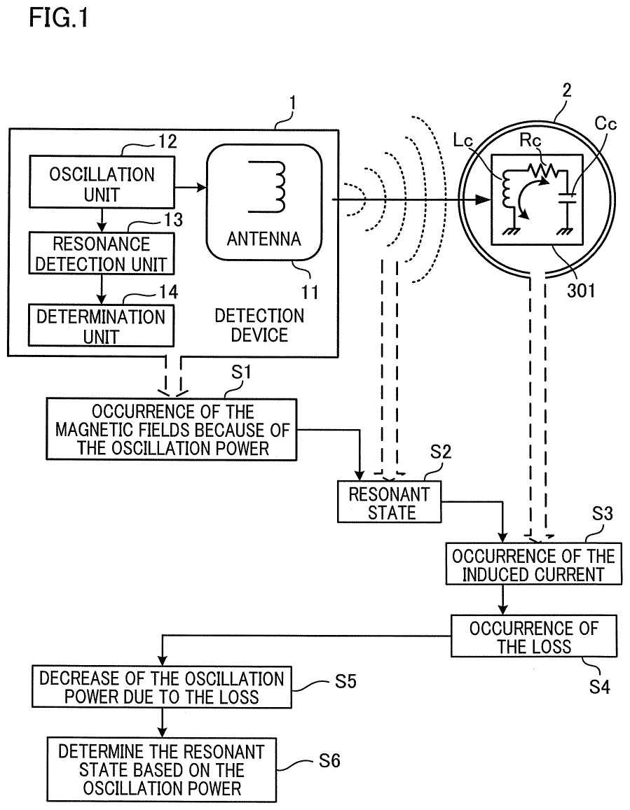

As shown in FIG. 1, a detection device 1 of the present embodiment is configured to detect an electronic circuit device 2 on the basis of whether the device 2 is in a resonant state. The electronic circuit device 2 has a unique resonance frequency, and performs data communication by power obtained by resonance.

To be more specific, the detection device 1 includes an antenna 11 for emitting a radio wave at the resonance frequency to the electronic circuit device 2, an oscillation unit 12 which outputs an oscillation signal at the resonance frequency to the antenna 11, a resonance detection unit 13 which detects a resonant state occurring between the antenna 11 and the electronic circuit device 2, a determination unit 14 which determines the existence of the electronic circuit device 2 on the basis of the resonant state detected by the resonance detection unit 13.

Because of this, the detection device 1 is able to detect the electronic circuit device 2 when the electronic circuit device 2 and the antenna 11 become in the resonant state, without increasing electric power used for resonance to a level at which data communication is possible. As a result, the power consumption of the detection device 1 can be reduced.

The following describes how the detection device 1 operates: to begin with, the oscillation unit 12 generates an oscillation signal indicating the resonance frequency with predetermined oscillation power, and outputs the signal to the antenna 11. The antenna 11 generates a radio wave which is a magnetic field or an electromagnetic field at the resonance frequency, as an alternate current of the oscillation signal flows (S1). The electronic circuit device 2 is in a resonant state if a magnetic field or an electromagnetic field at the resonance frequency exists (S2), and an induced current provided by electromagnetic induction is stably generated by resonance (S3). If the induced current runs in the electronic circuit device 2, power is decreased by a resistance component of the current path (S4). As a result, this loss of the power decreases the oscillation power of the detection device 1 (S5).

Because of this, only by determining the existence of the resonant state on the basis of the decreased amount of the oscillation power, the detection device 1 is able to detect the existence of the electronic circuit device 2 without activating the electronic circuit device 2 (S6). In other words, the detection device 1 is able to detect the electronic circuit device 2 based on the existence of the resonant state, before induced power becomes larger than the driving power of the electronic circuit device 2 and the electronic circuit device 2 becomes able to perform data communication.

As such, the detection device 1 is able to detect the electronic circuit device 2 when the electronic circuit device 2 and the antenna 11 are in the resonant state, by performing a detection method, without increasing power provided by resonance to a level at which data communication is possible. The detection method includes a process of outputting the oscillation signal at the resonance frequency to the antenna 11 for emitting a radio wave to the electronic circuit device 2, and a process of detecting the electronic circuit device 2 on the basis of the resonant state occurring between the antenna 11 and the electronic circuit device 2.

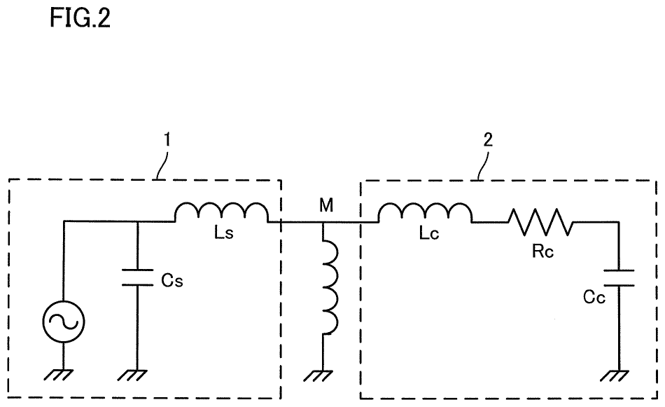

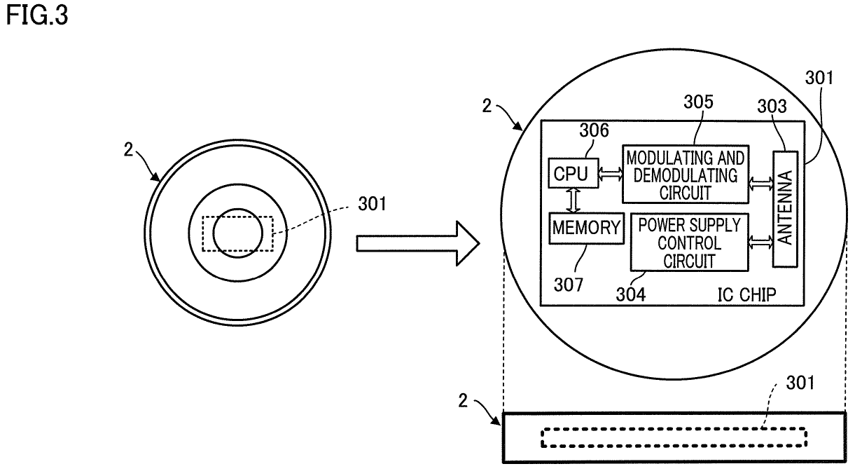

In regard to the detecting operation in the detection device 1, to be more specific, because the electronic circuit device 2 is configured to obtain power by resonance, the electronic circuit device 2 includes an antenna constructing a resonance circuit formed of a coil L, a resistor R, and a capacitor C. A specific example of the electronic circuit device 2 will be described later with reference to FIG. 3. The resonance circuit is tuned to a resonance frequency fc expressed by a relation fc=1/(2π√(Lc×Cc)). Therefore, in a case in which the electronic circuit device 2 is in the vicinity of the antenna 11 of the detection device 1, an aerial is constructed between the antennas by the occurrence of electromagnetic induction so that a transmitter LC circuit of the detection device 1 and a receiver LC circuit of the electronic circuit device 2 are coupled, and an equivalent circuit of FIG. 2 is constructed. Because of this, current runs in a receiver impedance. In the figure, M indicates a coupling coefficient of magnetic circuits of the antenna 11 of the detection device 1 and the antenna of the electronic circuit device 2.

In a case in which such an equivalent circuit is constructed by electromagnetic coupling, when a resonance frequency formed by LsCs of the detection device 1 (transmitter) becomes equal to a resonance frequency formed by the antenna LcCc of the electronic circuit device 2, the Q factor of the circuit viewed from the transmitter is decreased. As a result, power consumption is large because of increase of the loss. In addition to that, in the electronic circuit device 2, an impedance formed by LcCc as the antenna is lost, and a current runs in a load-resistance Rc by power which is excited by a radio wave (electromagnetic waves) or a magnetic field sent from the detection device 1 and received by the antenna of the electromagnetic device 2.

Because of this, in a case in which the electronic circuit device 2 is moved to the vicinity of the antenna 11 of the detection device 1 and the frequency of the oscillation power of the detection device 1 is tuned to the antenna of the electronic circuit device 2, the Q factor of the oscillation circuit is decreased, and the oscillation power is also decreased. Therefore, the detection device 1 is detectable by measuring the oscillation power in real time and by detecting decrease of the oscillation power. A specific structure of measuring the oscillation power in real time will be described later.

Because the decrease of the oscillation power depends only on the antenna of the electronic circuit device 2 which approaches the antenna 11 of the detection device 1, required power is not as large as power which drives processing circuits such as an IC chip built in the electronic circuit device 2, and the decrease of the oscillation power depends only on the tuned frequency of the antenna of the electronic circuit device 2.

### Electronic Circuit Device

As shown in FIG. 3, the electronic circuit device 2 has therein an IC chip 301. The IC chip 301 includes a memory 307 which stores sets of information including unique identification information, a CPU 306 which performs a controlling operation such as analyzing a received signal and sending the identification information, a modulating and demodulating circuit 305 which modulates transmission data such as the identification information and demodulates received data at the same time, an antenna 303 which performs sending of the transmission data and receiving of the received data, and a power supply control circuit 304 which supplies driving power. The antenna 303 forms the equivalent circuit of FIG. 2 by being coupled with the antenna 11 of FIG. 1.

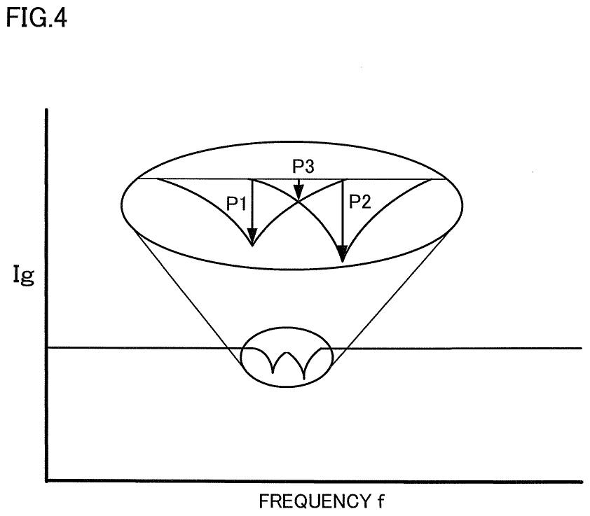

As shown in FIG. 4, preferably, a resonance frequency of each electronic circuit device 2 differs between the types. This is because, when the detection device 1 detects an electronic circuit device 2 based on a resonant state, a type of the electronic circuit device 2 is determinable based on the difference of the resonance frequency. To be more specific, even though RFID tags are manufactured based on a standard (e.g., ISO/IEC14443, ISO/IEC15693, and ISO/IEC18000-3 which use 13.56 MHz), a resonance frequency may be slightly different between product groups or manufacturers, because of differences in, e.g., material, design, and manufacturing processes. By understanding this difference in the resonance frequency, it may be possible to specify a product group or a manufacturer. In regard to the range of difference in the resonance frequency, preferably, generation bands of induced currents which are respectively peaked at peak values P1 and P2 are preferably overlapped at a part P3. In this case, the electronic circuit devices 2 are identifiable by the detection device 1, and plural electronic circuit devices 2 are activatable by a single detection device 1 in such a way that a driving output unit which is able to output the driving power at the resonance frequency to the detection device 1 is mounted on the detection device 1. In this regard, FIG. 4 shows a relationship between the frequency and the induced current of two different resonance frequencies (two types of the electronic circuit devices 2). However, the present invention is not limited to this, and three types or more may be applicable.

In the technical field of games, the electronic circuit device 2 stores gaming value information in the memory 307. In this regard, for example, a coin, a banknote, electrically valuable information corresponding to these, or nonvaluable information such as a game point which does not include valuable information is used as “gaming value information”. Examples of the electronic circuit device 2 including a gaming value are a chip, a token, an electronic money card, a plaque, and the like. The gaming value includes an exchangeable gaming value which is exchangeable into currency, and an unexchangeable gaming value which is unexchangeable into currency.

The electronic circuit device 2 is not limited to the technical field of games, and may be used in other technical fields. For example, the electronic circuit device 2 may be configured in such a way that an RFID tag is provided on a product such as clothing, food, a tool, an inspection unit, an ID card, and a book, which does not include an antenna. The electronic circuit device 2 in this case is detectable on the basis of a resonance frequency corresponding to an antenna of the RFID tag, even if each product does not include the antenna. Alternatively, the electronic circuit device 2 may be a portable device such as a smartphone and a mobile phone, which includes an antenna. The electronic circuit device 2 in this case is detectable on the basis of a resonance frequency corresponding to the antenna included in the portable device. Alternatively, an RFID tag may be provided on the portable device and the device is detected on the basis of the resonance frequency corresponding to this RFID tag.

### SPECIFIC EXAMPLE 1 OF DETECTION DEVICE

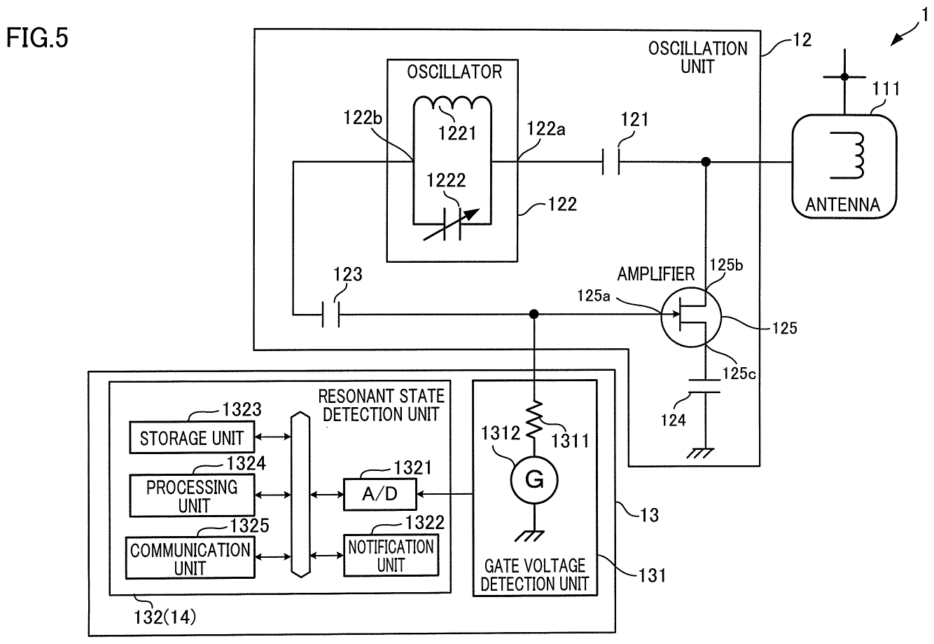

FIG. 5 is a block diagram showing a specific example 1 of the detection device 1. The antenna 11 of the detection device 1 may be variously shaped and sized. The detection device 1 is not required to generate a current which is large enough to drive the processing circuits such as the IC chip of the electronic circuit device 2. Therefore, in the antenna 11, a coupling coefficient M with the electronic circuit device 2 is very small. In order to enhance discriminability of the antenna in the detected electronic circuit device 2, preferably, the coupling coefficient M is as small as possible on condition that the detection device 1 is able to detect the electronic circuit device 2.

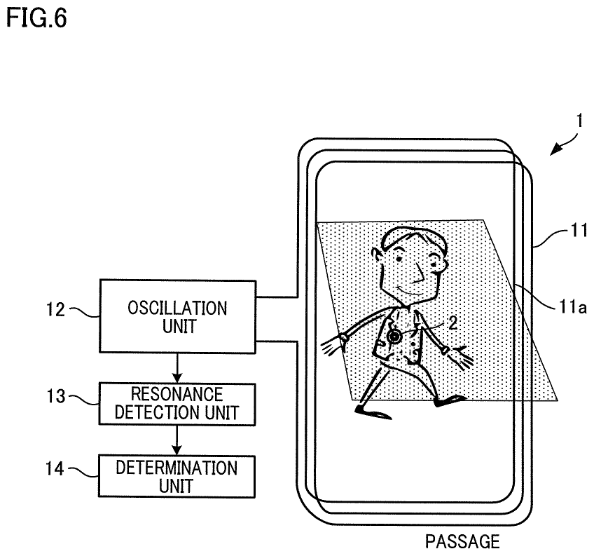

As shown in FIG. 6, for example, the antenna 11 may have an opening portion 11a having a size and shape allowing a person with the electronic circuit device 2 to pass therethrough. In this case, by setting the antenna 11 so that a passage is placed in the opening portion 11a, it is possible to avoid, for example, a situation in which the antenna 11 obstructs a person from walking.

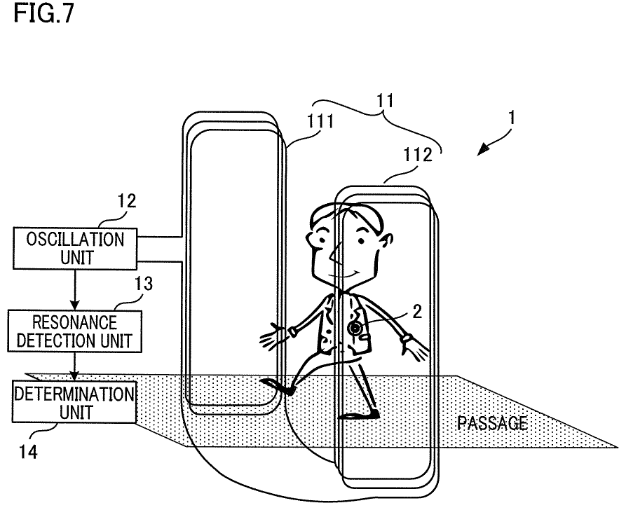

As shown in FIG. 7, the antenna 11 may include a pair of antenna members 111 and 112. In this case, because the antenna members 111 and 112 can be provided to the left of and to the right of a passage, the distance between the antenna members 111 and 112 is adjustable in accordance with the size of the electronic circuit device 2 which is a detection target and the size of the person with the electronic circuit device 2. In addition to that, because the antenna members 111 and 112 can be set by simply providing them on the floor, the setting is easy.

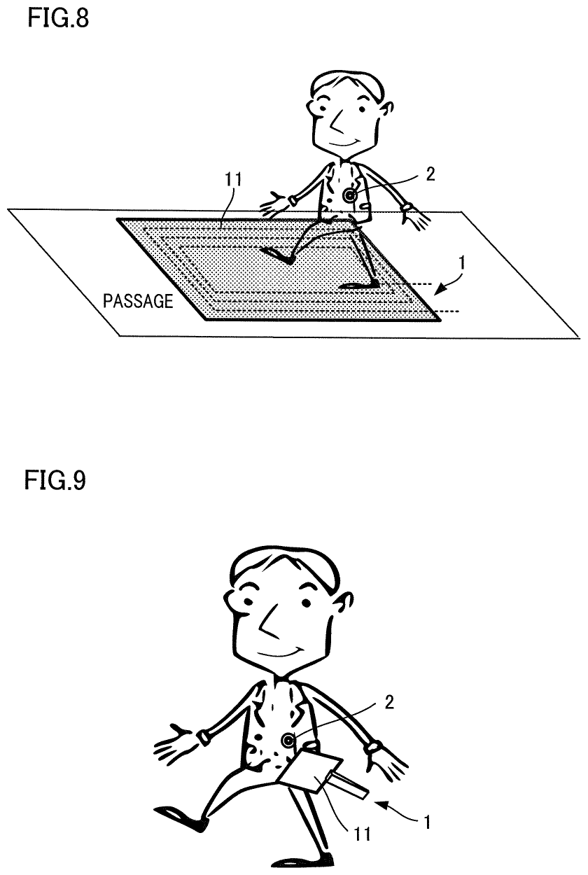

As shown in FIG. 8, the antenna 11 may be shaped in a form of a carpet or rug. In this case, the antenna 11 can be set only by simply spreading it on the passage or floor. As shown in FIG. 9, the antenna 11 may be portable. In this case, because the antenna 11 is freely movable with the person, handleability is improved.

As shown in FIG. 5, the antenna 11 is connected to an oscillation unit 12. The oscillation unit 12 includes an oscillator 122 which outputs an oscillation signal formed of an alternate current of the resonance frequency, and an amplifier 125 which amplifies the oscillation signal. The oscillator 122 includes a resonance circuit formed of a coil 1221, a capacitor 1222, and a resistor. The resonance circuit of the oscillator 122 adopts a series resonance or a parallel resonance as an oscillation method. In the capacitor 1222 of the oscillator 122, preferably, electrostatic capacity is changeable. In this case, by changing the electrostatic capacity of the capacitor 1222, oscillation signals at resonance frequencies can be generated, and the resonance frequency is finely adjustable so as to correspond to the electronic circuit device 2 which is a detection target.

One output terminal 122a of the oscillator 122 is connected to the antenna 11 through the capacitor 121. The other output terminal 122b of the oscillator 122 is connected to the amplifier 125 through the capacitor 123. The amplifier 125 is constructed by a field effect transistor (FET) which amplifies the oscillation signal. The field effect transistor includes a base terminal 125a into which the oscillation signal is input from the oscillator 122, and a drain terminal 125b which is connected to the antenna 11. By controlling a current flowing between the drain terminal 125b and a source terminal 125c in accordance with the gate voltage of the oscillation signal which is input into the base terminal 125a, a current of the oscillation signal running in the antenna 11 is controlled. The source terminal 125c is connected to the ground through the capacitor 124.

Between the capacitor 123 and the amplifier 125, a resonance detection unit 13 is connected. The resonance detection unit 13 includes a gate voltage detection unit 131 which detects the gate voltage provided by the oscillation signal which is input into the base terminal 125a of a field effect transistor 125, and a resonant state determination unit 132 which determines the existence of the resonant state on the basis of the gate voltage detected in the gate voltage detection unit 131. The resonant state determination unit 132 further has a function of the determination unit 14 which determines the existence of the electronic circuit device 2 on the basis of the resonant state.

The gate voltage detection unit 131 includes a resistor 1311 which causes a current to flow in accordance with the voltage of the oscillation signal, and a current detector 1312 which detects a current value. The current detector 1312 outputs an analog current value to the resonant state determination unit 132. The resonant state determination unit 132 is constructed by an information processor including an A/D converter 1321, a notification unit 1322, a storage unit 1323, a processing unit 1324, and a communication unit 1325.

The A/D converter 1321 converts the current value supplied from the resonant state determination unit 132 into a digital amount. The storage unit 1323 stores data and programs which cause the processing unit 1324 to perform various processes. For example, the storage unit 1323 stores programs such as a process of determining the existence of the resonant state on the basis of the current value, a process of determining the existence of the electronic circuit device 2 on the basis of the resonant state, and a process of outputting detection information to an external apparatus and a display device 1322 when the electronic circuit device 2 is detected. The communication unit 1325 is connected to an unillustrated external apparatus in a communicable manner. Examples of the external apparatus include a notification device such as a rotary beacon light and a loudspeaker which output the detection information by sound or by light, and a centralized monitoring device which manages plural detection devices 1. Examples of the notification unit 1322 include a display device and a speaker which output the detection information by sound or by light.

### SPECIFIC EXAMPLE 2 OF DETECTION DEVICE

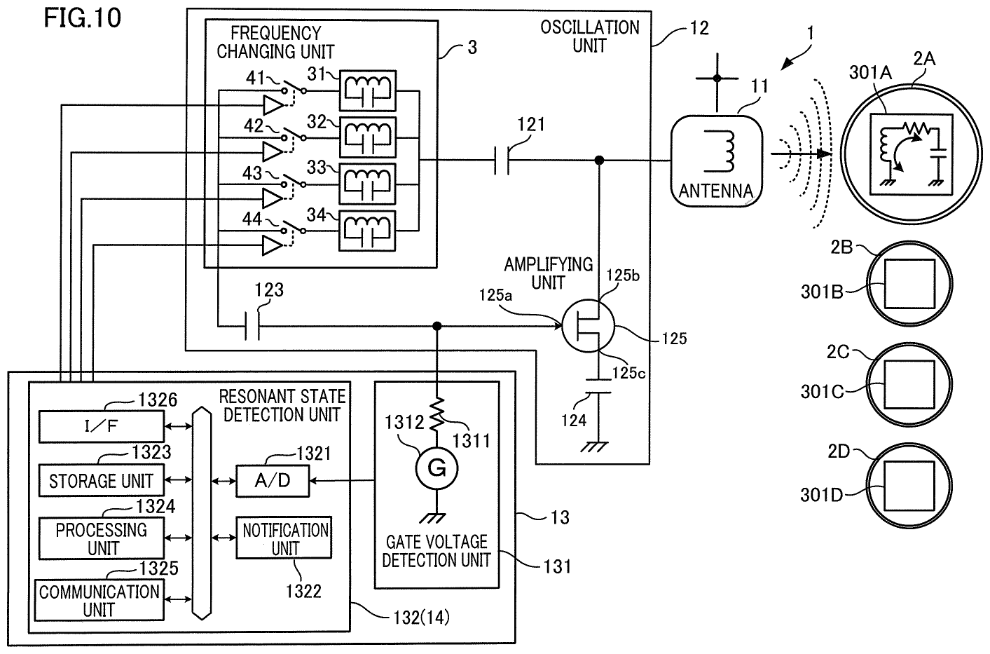

FIG. 10 is a block diagram showing a specific example 2 of the detection device 1. In regard to plural types of electronic circuit devices 2, a detection device 1 of the specific example 2 detects the electronic circuit device 2, and at the same time determines the type of the electronic circuit device 2 automatically. The following will describe a case in which electronic circuit devices 2A, 2B, 2C, and 2D include, as RFID tags, IC chips 301A, 301B, 301C, and 301D. The electronic circuit devices 2A, 2B, 2C, and 2D are formed in four different chip shapes. The IC chips 301A, 301B, 301C, and 301D have different resonance frequencies. The same reference numerals are assigned to components having substantially identical arrangements as those of the detection device 1 of the specific example 1, and the descriptions thereof are omitted.

An oscillation unit 12 of the detection device 1 includes a frequency changing unit 3 which changes the resonance frequency. The frequency changing unit 3 includes single oscillation units 31 to 34 which output oscillation signals at resonance frequencies which are different from each other, and connection switching units 41 to 44 which switch connections between the single oscillation units 31 to 34 and the antenna 11. Because of this, the oscillation unit 12 is able to form an oscillation signal in which a bandwidth of the resonance frequency is finely separated.

Each of the single oscillation units 31 to 34 is set so as to oscillate at the resonance frequency corresponding to the resonance frequency of each of the electronic circuit devices 2A to 2D. Each of the connection switching units 41 to 44 includes a switch which is switchable between an open state and a closed state, and these connection switching units 41 to 44 are connected to the respective single oscillation units 31 to 34. In addition to that, the connection switching units 41 to 44 include switch controlling units which switches the switches between the open state and the closed state. The switch controlling units are connected to an interface unit 1326 of a resonant state determination unit 132, and switch the switches between the open state and the closed state by a switching signal from the interface unit 1326. The connection switching units 41 to 44 may be a single IC chip including plural field effect transistors (FETs).

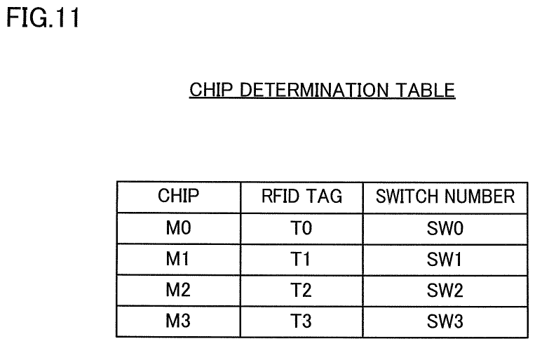

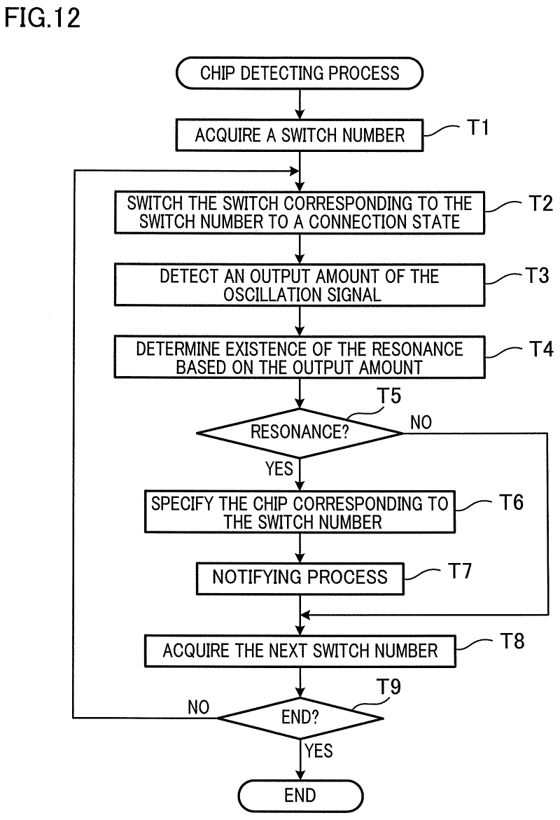

The resonant state determination unit 132 stores a chip determination table of FIG. 11, and a detection device controlling program of a chip detecting process routine of FIG. 12, in the storage unit 1323. The chip determination table includes types M0 to M3 of the chip in which the electronic circuit device 2 is shaped as a chip, RFID tags T0 to T3 which are built in each electronic circuit device 2, and switch numbers SW0 to SW3 which are associated with the connection switching units 41 to 44. For example, the connection switching unit 41 corresponding to the switch number SW0 is in the closed state, and the other connection switching units 42, 43, and 44 are in the open state. In this case, when a resonant state is detected, the resonant state is determined as the resonance with the RFID tag T0 corresponding to the switch number SW0, and it is determined that the type of the chip including this RFID tag T0 is M0.

The following provides a specific description on the basis of the chip detecting process routine of FIG. 12. To begin with, one of the switch numbers SW0 to SW3 is acquired with reference to the chip determination table (T1), the switch (one of the connection switching units 41 to 44) corresponding to the one of the switch numbers SW0 to SW3 is switched to a connection state, and the other switches are switched to a nonconnection state (open state; T2). With this, in a case in which the switch number SW1 is selected, oscillation at the resonance frequency corresponding to the single oscillation unit 32 is started, and an oscillation signal amplified by the amplifier 125 is output to the antenna 11 in such a way that an oscillation voltage is applied to the base terminal 125a of the amplifier 125. Then, a radio wave at the resonance frequency is output from the antenna 11.

Subsequently, in the resonance detection unit 13, a current value of the oscillation signal applied to the base terminal 125a is detected as an output amount (oscillation energy) of the oscillation signal (T3). Then, the existence of the resonance is determined on the basis of the output amount (T4). If the resonant state exists (YES in T5), the type of the chip corresponding to the selected one of the switch numbers SW0 to SW3 is specified as one of the types M0 to M3 (T6), and a notifying process using sound and light is performed (T7). After that, the next one of the switch numbers SW0 to SW3 is acquired (T8). For example, selection is made in accordance with the order of the switch numbers in the chip determination table. When the switch number SW1 was selected in the prior detection, the switch number SW2 is selected. Unless it is ended by operation of an unillustrated stop button or by receiving of an end signal (No in T9), when the next one of the switch numbers SW0 to SW3 is acquired, processes are performed from T2, radio waves of the resonance frequency corresponding to the next one of the switch numbers SW0 to SW3 are sent, and a detecting process which detects the resonant state with one of the electronic circuit devices 2A to 2D is performed.

Embodiments of the present invention thus described above solely serve as specific examples of the present invention, and are not to limit the scope of the present invention. The specific structures and the like are suitably modifiable. Further, the effects described in the embodiments of the present invention described in the above embodiment are no more than examples of preferable effects brought about by the present invention, and the effects of the present invention are not limited to those described hereinabove.

What is claimed is:

1. A detection device detecting an electronic circuit device which has a unique resonance frequency and performs data communication by power obtained by resonance, the detection device comprising:
an antenna configured to emit a radio wave at the resonance frequency to the electronic circuit device;
an oscillation unit configured to output an oscillation signal at the resonance frequency to the antenna;
a resonance detection unit configured to detect a resonant state occurring between the antenna and the electronic circuit device; and
a determination unit configured to determine existence of the electronic circuit device based on the resonant state detected by the resonance detection unit.

2. The detection device according to claim 1, wherein, the oscillation unit includes a frequency changing unit which is configured to change the resonance frequency.

3. The detection device according to claim 2, wherein, the frequency changing unit includes:
single oscillation units which output oscillation signals at different resonance frequencies; and
a connection switching unit which switches connection between the antenna and the single oscillation units.

4. The detection device according to claim 1, wherein, the oscillation unit includes:
an oscillator which is configured to output the oscillation signal; and
a field effect transistor which includes a base terminal into which the oscillation signal is input from the oscillator and a drain terminal connected to the antenna, and is configured to control a current of the oscillation signal running in the antenna by controlling a current between the drain terminal and a source terminal in accordance with a gate voltage of the oscillation signal which is input into the base terminal, and
the resonance detection unit includes:
a gate voltage detection unit which is configured to detect the gate voltage of the oscillation signal which is input into the base terminal; and
a resonant state determination unit which is configured to determine existence of the resonant state based on the gate voltage detected in the gate voltage detection unit.

5. The detection device according to claim 1, wherein, the antenna includes an opening portion which allows a person with the electronic circuit device to pass through.

6. A detection method of detecting an electronic circuit device which has a unique resonance frequency and performs data communication by power obtained by resonance, the detection method comprising the steps of:
outputting an oscillation signal at the resonance frequency to an antenna which is provided to emit a radio wave to the electronic circuit device; and
detecting the electronic circuit device based on a resonant state occurring between the antenna and the electronic circuit device.
